(19) United States
(12) Patent Application Publication
(10) Pub. No.: US 2021/0070007 A1
(43) Pub. Date: Mar. 11, 2021

(54) Compostable Laminated Food Tray

(71) Applicant: Innovation Fiber, LLC, Delafield, WI (US)

(72) Inventor: Jeffrey S. Covelli, Delafield, WI (US)

(21) Appl. No.: 17/014,044

(22) Filed: Sep. 8, 2020

Related U.S. Application Data
(60) Provisional application No. 62/896,746, filed on Sep. 6, 2019.

(51) Int. Cl. B32B 1/02; B32B 7/12; B32B 27/10; B32B 29/00; B32B 3/08; B65D 1/34; B65D 65/40; B65B 5/04; B65B 7/28; B65D 65/46

(52) U.S. Cl. CPC B32B 1/02; B32B 7/12; B32B 27/10; B32B 29/005; B32B 3/08; B65D 1/34; B32B 2439/70; B65B 5/04; B65B 7/2878; B65D 65/466; B32B 2250/02; B32B 2307/7163; B65D 65/40

(57) ABSTRACT

A compostable food tray is provided including an upper layer formed of a flexible and compostable material that is secured to a lower layer formed of a foldable and compostable material. The lower layer can be folded to form a tray including an interior for holding a food item therein, while the upper layer extends beyond the periphery of the lower layer and can be wrapped over or around the food item in order to provide a package for the food item in conjunction with the lower layer.

### CROSS-REFERENCE TO RELATED APPLICATIONS

The present application claims priority from U.S. Provisional Patent Application Ser. No. 62/896,746, filed on Sep. 6, 2019, the entirety of which is expressly incorporated herein by reference for all purposes.

### FIELD OF THE DISCLOSURE

The present invention relates generally to food containers, such as trays, and more specifically to a container for holding food items therein.

### BACKGROUND OF THE DISCLOSURE

Trays are often utilized to both support and provide a package for a number of different types of food items placed on or in the trays. In most situations, the tray is formed with a bottom surface for holding the food item thereon, and a number of side walls that extend upwardly from the periphery of the bottom surface. With this construction for the tray, the bottom surface supports the food item within the tray while the side walls retain the food item within the tray over the bottom surface.

In addition to holding the food item within the tray, the trays for holding food items must often be constructed in a manner that prevents the food item from degrade or otherwise detrimentally affecting the ability of the material forming the tray to support the food item within the tray.

With regard to meat and similar high-moisture content food products, a tray must be able to support the weight of the meat product while additionally being able to resist degradation due to the effects of the moisture contained within the meat product held on the tray.

In the prior art, one specific type of material that has been used for this particular purpose is a foam material. The foam material is lightweight, but has sufficient strength to be able to hold meat and similar products thereon. Further, the foam material has a fluid-impervious nature which enables the foam material to effectively repel the moisture from the meat or other food product on the tray, which is a significant advantage over paperboard tray materials which are highly susceptible to degradation from moisture from the food product located on the tray.

However, the foam trays have certain significant drawbacks associated with their use. Primarily, the foam material itself is highly limited in its capacity to be recycled, such that it is environmentally undesirable to use the foam material for this reason alone.

In addition, to hold the meat or other food product on the tray, an overwrap must be positioned over the meat and tray. This overwrap is normally formed of a plastic material that can readily adhere to the foam tray and can conform to the shape of the meat or food item on the tray.

However, similar to the foam material forming the tray, the overwrap is formed of a material that is often not recycled. Further, the overwrap does not have significant strength and is easily punctured, such that the meat is exposed to the exterior environment and/or the fluids in the meat are prematurely released from the tray, causing spills and other messes that must be addressed.

As a result, it is desirable to develop a tray for holding meat and similar products that has the same or improved capabilities from a foam tray to support the product and withstand the moisture emitted by the meat or other food item, but with a significantly different recycling profile.

### SUMMARY OF THE DISCLOSURE

According to one aspect of the present disclosure, a food tray is provided that includes a flexible fluid resistant layer applied to a based formed of a more rigid supporting material. The fluid resistant layer is laminated or otherwise adhered to the base layer to be retained in place on the base layer. The fluid resistant layer extends beyond the boundaries of the support layer such that the edges of the fluid resistant layer can be wrapped or otherwise secured around the meat or other food item placed on the fluid resistant layer to cover and hold the food item thereon while being supported on the supporting base layer.

According to another exemplary aspect of the present disclosure, the supporting base layer can include a number of foldable sections, such that the base layer can be folded into a container-like configuration. In this configuration the base layer provides support below the fluid resistant layer and the food item positioned therein in addition to providing a retaining function as a result of the folded sections of the base layer disposed on the sides of the food item.

According to a further exemplary aspect of the present disclosure, the fluid resistant layer and the base layer are each formed from readily compostable and/or recyclable materials.

Numerous other aspects, features, and advantages of the present disclosure will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a top perspective view of a compostable food tray constructed according to the present disclosure;

FIG. 2 is a bottom perspective view of the compostable food tray of FIG. 1;

FIG. 3 is a top plan view of the compostable food tray of FIG. 1 with the base layer in a retaining configuration; and

FIG. 4 is a partially broken away side plan view of the compostable food tray of FIG. 3.

### DETAILED DESCRIPTION OF THE DISCLOSURE

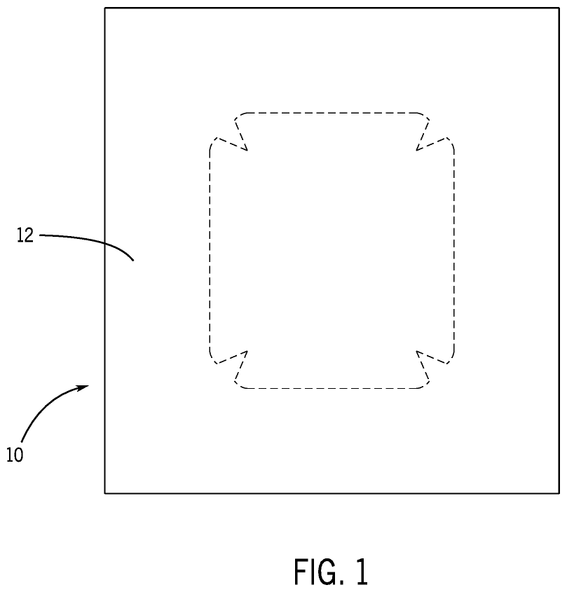

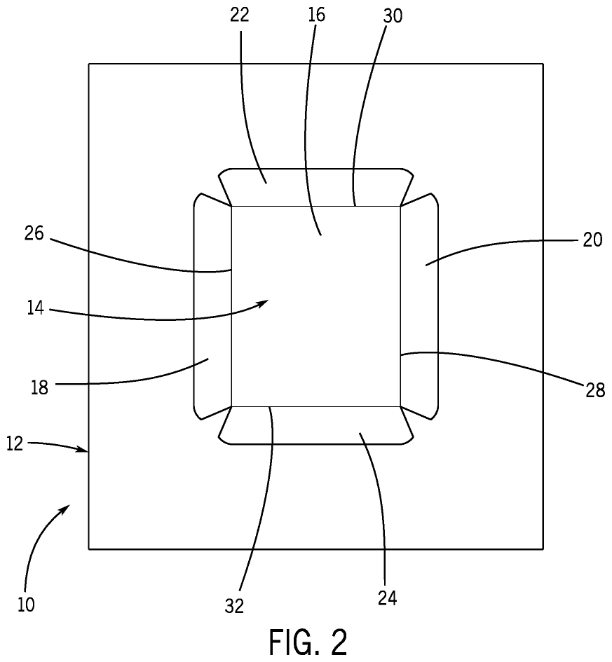

Referring now in detail to the drawing figures, wherein like reference numerals represent like parts throughout the several views, one embodiment of a food tray constructed according to the present disclosure is illustrated generally at 10 in FIGS. 1 and 2. The tray 10 includes an upper fluid resistant layer 12 and a lower supporting base layer 14.

The upper layer 12 can have any desired shape or configuration and in the illustrated exemplary embodiment is formed as a generally rectangular shaped layer. The layer 12 can be formed of any suitable and flexible material, such as a paper layer, including kraft paper, e.g., butcher paper, that is readily compostable and/or recyclable. The material forming the layer 12 can be uncoated or can have any suitable coating or wax or other material applied thereto to provide the desired characteristics for the layer 12, e.g., making the layer 12 fluid resistant and/or leak-proof. The material forming the layer 12 has a thickness of between (insert normal thickness ranges here for paper layer) such that the desired properties for the layer 12 can be provided along with allowance for the material forming the layer 12 to be flexible. The peripheral shape of the layer 12 can be selected as desired, and in the illustrated exemplary embodiment is generally rectangular in shape to enable the layer 12 to adequately cover the food item positioned within the tray 10.

The lower supporting base layer 14 has a shape smaller than that of the upper layer 12, such that the upper layer 12 extends beyond the periphery of the lower layer 14 in at least one direction, and in the exemplary illustrated embodiment of FIG. 2, in all directions. In the illustrated exemplary embodiment of FIG. 2, the lower layer 14 has a generally rectangular shape with a periphery smaller than that of the upper layer 12 such that the upper layer 12 extends beyond the periphery of the lower layer 14 on all sides of the lower layer 14.

The lower layer 14 is formed of a suitably rigid but bendable or foldable material, such as a corrugated material and/or paperboard material, that is readily compostable and/or recyclable and which can include a moisture resistant coating, or any other suitable coating(s) or application(s) thereon to provide the desired characteristics for the lower layer 14, e.g., making the lower layer 14 moisture resistant and/or leak-proof, or strengthening the lower layer 14, or providing suitable indicia or printing (not shown) on the lower layer 14.

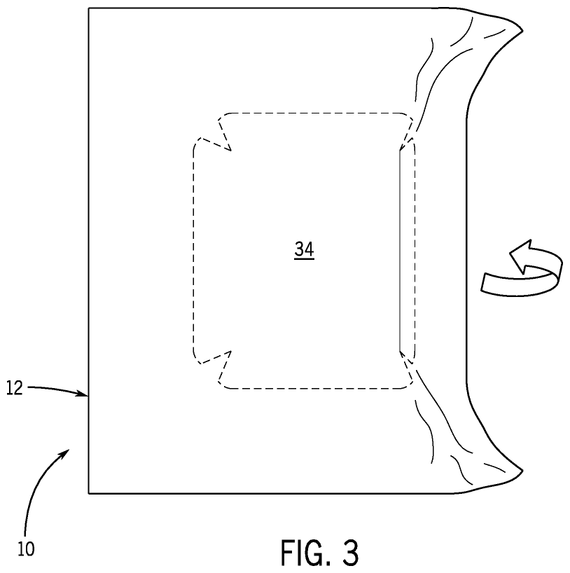

The lower layer 14 includes a central portion 16 disposed at the center of the lower layer 14, a pair of opposed side panels 18,20 extending outwardly from opposite sides of the central portion 16, and a pair of opposed end panels 22,24 extending outwardly from opposed ends of the central portion 16. In the illustrated exemplary embodiment, the side panels 18,20 and end panels 22,24 are each integrally formed with the central portion 16 and are foldable with respect thereto, such as along scores or fold lines 26-32 between the central portion 16 and each panel 18-24. The ends of each side panel 18,20 and end panel 22,24 may include securing features (not shown), such as various mechanical securing members and/or an adhesive, for example, capable of engaging complementary features or tabs 25 on the ends of adjacent panels 18-24 when the panels 18-24 are folded towards one another with regard to the central portion 16. The engagement of the securing features on the tabs 25 with each other operates to hold the panels 18-24 of the lower layer 14 in a product retaining configuration, as best shown in the illustrated exemplary embodiment FIG. 3.

The upper layer 12 is attached to the lower layer 14 in order to retain the upper layer 12 in a stationary position on the lower layer 14 and to maintain the upper layer 12 and the lower layer 14 together as a single member for the tray 10. The upper layer 12 can be secured or otherwise affixed to the lower layer 14 in any suitable manner, such as by adhering, laminating or otherwise affixing the upper layer 12 to the lower layer 14. As best shown in the illustrated exemplary embodiment of FIGS. 1 and 2, the manufacture of the tray 10 can include the securing of the upper layer 12 to a lower layer 14 in a flat configuration to increase the speed and ease of the manufacture of the tray 10.

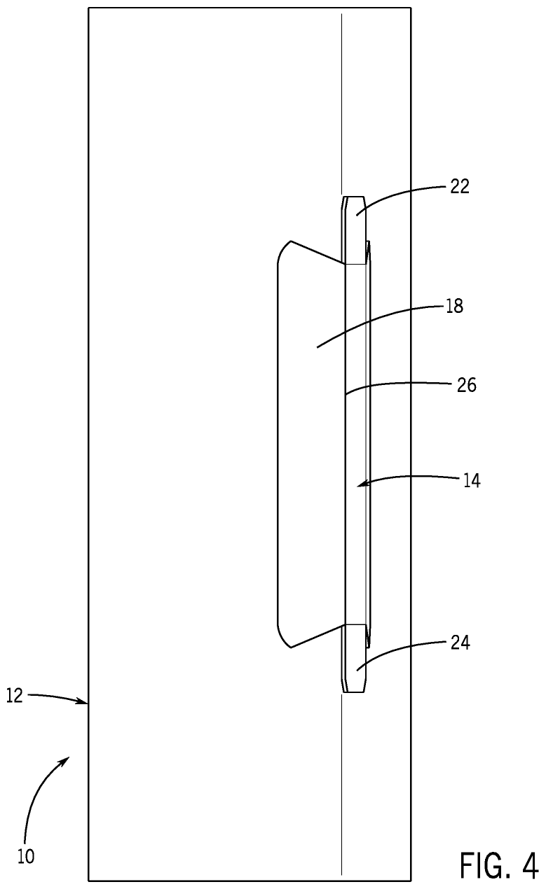

In use, a tray 10 in a flat configuration (FIGS. 1 and 2) is initially placed near a food item to be placed therein. The lower layer 14 is then shaped into the retaining configuration of FIGS. 3 and 4 by folding the side panels 18,20 and end panels 22,24 (FIG. 4) with regard to the central portion 16 to enable the tabs 25 on adjacent panels 18-24 to be secured to one another and form an interior 34 for the tray 10. In this configuration, the upper layer 12 is moved and/or folded along with the panels 18-24 and can conform to the shape of the interior 34 of the tray 10 based on the flexible nature of the material forming the upper layer 12.

When the tray 10 is in the retaining configuration of FIG. 3, the food item can be positioned within the interior 34 of the lower layer 14 directly on the area of the upper layer 12 disposed within the interior of the lower layer 14. Subsequently, the portions of the upper layer 12 extending beyond the periphery of the lower layer 14 can be wrapped around and secured over the food item in the tray 10 in a suitable manner to form an enclosed package for the food item on the tray 10. In this configuration, the tray 10 can support the food item for transport, display and sale, such that the upper layer 12 can be removed from over the food item when it is desired to unpackage and utilize the food item therein.

In alternative exemplary embodiments, the lower layer 14 can be formed from a corrugated and/or paperboard material and can have a simple flat shape, e.g., rectangular, including only the central portion 16, without and panels 18-24, or with a different number of panels 18-24. The upper layer 12 can be formed from kraft paper or another flexible material, such as a plastic film (not shown), that can be attached, such as hermetically sealed, to the lower layer 14. In this configuration, the upper layer 14 extends around al the edges of the lower layer 12. In the formation process, the cost to process the lower layer 14 is far less than forming a conventional tray by omitting the secondary process after die cutting the tray blank to form the flat material into a tray. In the present disclosure, the exemplary process for forming the lower layer 14 is die cutting the material forming the lower layer 14 and subsequently adhering or sealing the upper layer 12 to the lower layer 14 in order to form the tray 10.

Changes can be made in the above constructions and method steps without departing from the scope of the invention, it is intended that all matter contained in the above description or shown in the accompanying drawings shall be interpreted as illustrative and not in a limiting sense. Various other embodiments of the present invention are contemplated as being within the scope of the filed claims particularly pointing out and distinctly claiming the subject matter regarded as the invention.

1. A tray for supporting and containing a food item therein, the tray comprising:
a. a lower layer formed of a paperboard material; and
b. an upper layer formed of a flexible material secured to the lower layer, wherein the upper layer has a perimeter larger than a perimeter of the lower layer.

2. The tray of claim 1 wherein the upper layer is formed of a recyclable material.

3. The tray of claim 2 wherein the upper layer is formed of a thermoplastic material.

4. The tray of claim 2 wherein the upper layer is formed of a paper material

5. The tray of claim 4 wherein the upper layer is formed of a kraft paper.

6. The tray of claim 1 wherein the upper layer is adhered to the lower layer.

7. The tray of claim 6 wherein the lower layer has a central portion and the upper layer is adhered to the central portion.

8. The tray of claim 7 wherein the lower layer includes a number of side panels foldably attached to sides of the central portion.

9. The tray of claim 8 wherein the side panels are integrally formed with the central portion.

10. The tray of claim 8 wherein the side panels include tabs that are secured to one another.

11. The tray of claim 11 wherein the tabs are adhered to one another.

12. A method for forming a food item package, the method comprising the steps of:
a. providing a tray formed of a lower layer formed of a paperboard material and an upper layer formed of a flexible material secured to the lower layer, wherein the upper layer has a perimeter larger than a perimeter of the lower layer;
b. placing a food item within the on the upper layer over the lower layer; and
c. covering the food item with the upper layer.

13. The method of claim 12 wherein the lower layer includes a central portion and a number of panels attached to sides of the central portion, and wherein the method further includes the step of folding the panels relative to the central portion to define an interior for the tray prior to placing the food item.

14. The method of claim 13 wherein the number of panels each includes tabs and wherein the method further comprises the step of engaging adjacent tabs with one another to form the tray defining the interior.
